(19) United States
(12) Patent Application Publication
(10) Pub. No.: US 2026/0358264 A1
(43) Pub. Date: Nov. 12, 2026

(54) System for analyzing a sample by laser beam, comprising a device for capturing a profile of the laser beam, and method for adjusting such a system

(71) Applicant: FARIAUT INSTRUMENTS, ORLEANS (FR)

(72) Inventor: François FARIAUT, Saint Jean de la Ruelle (FR)

(21) Appl. No.: 19/140,113

(22) PCT Filed: Dec. 18, 2023
(86) PCT No.: PCT/EP2023/086492

§ 371 Date: Jun. 17, 2025

(30) Foreign Application Priority Data
Dec. 20, 2022 (FR) FR2213971

(51) Int. Cl. G01N 21/88; G01J 1/42; G01J 3/443; G01N 21/71

(52) U.S. Cl. CPC G01N 21/8806; G01J 1/4257; G01J 3/443; G01N 21/718; G01N 2201/06113

(57) ABSTRACT

A system for elemental analysis of a sample to be studied. The analysis system includes a capturing device for capturing characteristics of a laser beam emitted by a generation module, intended to be interposed between a shaping module and focusing optical elements. The capturing device includes: a deflection mirror; a photosensitive cell; optical linear magnifier; and a transmitter for transmitting the image acquired by the photosensitive cell to a display device.

### CROSS-REFERENCE TO RELATED APPLICATIONS

This Application is a Section 371 National Stage Application of International Application No. PCT/EP2023/086492, filed Dec. 18, 2023, and published as WO 2024/133165 A1 on Jun. 27, 2024, not in English, which claims priority to and the benefit of French Patent Application No. 2213971, filed Dec. 20, 2022, the contents of which are incorporated herein by reference in their entireties.

### FIELD OF THE DISCLOSURE

The present invention relates to the field of high-resolution mapping and analysis of elements in solids.

More particularly, the invention relates, in particular but not exclusively, to a high-resolution analysis device for mapping elements in metallic solids.

The invention can in particular apply to the elemental analysis of hydrogen and oxygen by optical emission spectrometry on laser-produced plasma, in the field of the nuclear industry, or in the aviation or space industry.

### BACKGROUND OF THE DISCLOSURE

In applications such as the characterization of devices subjected to radioactive sources, or the characterization of the aging ability of devices used in particularly harsh environments, for example in aircrafts or spacecrafts, elemental analysis of metal samples could prove to be essential.

More specifically, it may prove necessary to be able to map these elements within the analyzed sample. Mapping means an identification of the elements making up the sample analyzed and, optionally, the distribution and the bond between the various elements.

Such an analysis could prove particularly useful in studies of metal embrittlement by hydrogen, or in studies of aging of fuel cladding in the presence of oxygen, or in studies of embrittlement of fuel cladding caused by the formation of hydrides, these promoting the propagation of cracks.

There are various known methods of mapping elements present in samples.

One of these methods is elemental analysis by optical emission spectrometry on laser-produced plasma, a technique practiced in a natural atmosphere, also referred to by the English acronym “LIBS” corresponding to the English expression “laser induced breakdown spectroscopy”.

This method applies in particular to the in situ inspection and characterization of samples of parts to be analyzed.

A method and a device for elemental analysis by optical emission spectrometry on laser-produced plasma in the presence of argon is described by the patent document published under number EP 0,654,663.

In practice, an analysis system is used to emit a laser beam onto a part to be analyzed. The laser beam is emitted by a laser source and then passes through different lenses and diaphragms before impacting the part to be analyzed.

The impact of the laser beam on the part to be analyzed results in the creation of a plasma the closest to which an optical fiber is positioned allowing acquiring an image which is analyzed by ad hoc software to determine the elemental mapping of the constituent material of the part to be analyzed, i.e. to establish an accurate identification of the constituent components of the material of the analyzed sample.

When using the system, external parameters such as vibrations and even temperature can influence the emission of the beam and reduce the quality of the analysis.

Indeed, temperature and/or vibrations can shift the position of the diaphragms, of the lenses and/or of the laser source.

As a result, upon impact on the part to be analyzed, the beam is not homogeneous and has a different power at each point of its contour.

In other words, the laser beam features, in a cross-section, a variation in power over its contour while it should have an equal power at every point of its contour.

Henceforth, when the laser beam is not homogeneous and does not have a desired profile (corresponding to an ideal alignment of the generation module, of the lens(es) and of the diaphragm(s)), its impact on the part to be analyzed creates a crater (due to the ablation of the part by the laser beam) which, depending on its depth, has a substantially frustoconical shape. On the other hand, in the case of a homogeneous beam with a desired profile, the crater has an optimum shape which is substantially cylindrical with a circular section. A homogeneous laser beam is commonly referred to as “top hat” in English.

This then requires a step of calibrating the system, i.e. repositioning the laser source, the diaphragm(s) and/or the lens(es) so that the beam is correctly aligned and the crater has an optimum shape.

Such a calibration is carried out empirically, which is tedious and time-consuming, such that it is generally carried out approximately, until the beam is in an alignment deemed suitable, i.e. an alignment close to an optimum theoretical alignment.

Indeed, to carry out this adjustment, a laser beam is emitted to impact a test part so that the shape of the impact is analyzed.

By analyzing the shape of the impact, it is possible to determine whether the beam is properly aligned or not and to proceed with the adjustment of the position of the diaphragms, of the lenses, and/or of the laser source.

However, the identification of each misaligned item (diaphragm, lens, or laser source) is not simple and could make the adjustment of the system more complex.

Indeed, the position of an element that was initially correctly positioned could be modified by error. This results in an aggravation of the alignment defect, which lengthens the time required for the calibration of the system.

### SUMMARY

In particular, an objective of the invention is to overcome the drawbacks of the prior art.

More specifically, an objective of the invention is to provide a laser beam analyzer allowing simplifying and accelerating the adjustment of the laser beam of an analysis system.

Another objective of the invention is to provide such a laser beam analyzer which ensures an instantaneous reading of the homogeneity of the laser beam.

A further objective of the invention is to provide such a beam analyzer which ensures an accurate reading of the homogeneity of the laser beam.

These objectives, as well as others that will appear later on, are achieved thanks to the invention which relates to a system for elemental analysis of a sample to be studied, including an analysis device comprising a frame on which are mounted:
a module for generating a laser beam,
a module for shaping the laser beam integrating at least one shaping lens and a diaphragm for selecting a portion of the laser beam emitted by the generation module,
optical means for focusing the laser beam on the sample to be studied, characterized in that the analysis system also comprises a device for capturing characteristics of the laser beam emitted by the generation module, intended to be interposed between the shaping module and the focusing optical means, the capturing device comprising:
a mirror for deflecting the laser beam, capable of adopting a deflection position in which the mirror generates a deflected laser beam;
a photosensitive cell intended to acquire an image of the deflected laser beam;
optical means for linearly magnifying the deflected laser beam, interposed between the deflection mirror and the photosensitive cell, and
means for transmitting the image acquired by the photosensitive cell to a display device.

The capturing device allows adjusting the analysis device rapidly and in non-destructive manner in comparison with the prior art.

Indeed, thanks to the capturing device, an image of the laser beam can be obtained, which allows adjusting the analysis device instantaneously, or almost so, since it is not necessary to obtain a thorough analysis of a crater in a part.

In other words, starting from a two-or three-dimensional digital image, it is possible to determine a profile and/or homogeneity defect of the laser beam and, iteratively and quickly, correct the position of the generation module, of the lens and/or of the selection diaphragm to modify the profile of the laser beam and/or its homogeneity.

Henceforth, the adjustment time is considerably reduced and can be performed visually, to the benefit and speed of adjustment of the analysis device, and therefore of the analysis quality.

For information, it is recalled that the linear magnification (also referred as lateral magnification) corresponds to a ratio of dimensions between an image of an object and the object itself, at determined distances.

It should be noted that the deflection mirror may be fully reflective or only partially reflective.

According to an advantageous aspect, the optical means for linearly magnifying the deflected laser beam comprise:
a first magnifying lens having a first focal length f1, and
a second magnifying lens having a second focal length f2,
   the first focal length f1 and the second focal length f2 being selected so that the ratio f2/f1 is greater than or equal to 2.

Such a ratio allows enlarging the image of the laser beam to enable the analysis of its profile and its homogeneity, rapidly and optimally.

In particular, the characteristics of the selection diaphragm are then no longer necessary, so that the capturing device can be used on different analysis devices.

According to another advantageous aspect, the capturing device is removably mounted on the frame.

This allows using one single capturing device on several different analysis devices.

Furthermore, this allows generating no risks of disturbance of the analysis or extraction of the capturing device when the analysis device is used.

According to another advantageous aspect, the capturing device comprises a plurality of reflecting mirrors interposed between the deflection mirror and the photosensitive cell, to enlarge the deflected beam by redirecting it according to several directions up to the photosensitive cell.

This directly benefits the compactness of the analysis system.

Indeed, by making the deflected beam travel according to a predetermined path, it is possible to bypass some elements of the analysis device, so as to integrate the capturing device into the system without increasing its footprint in an unjustified manner.

According to another advantageous aspect, at least one of the deflection mirrors, so-called the primary reflecting mirror, is positioned between the first lens and the second lens of the linearly magnifying optical means.

This positioning ensures a spacing of the first lens with respect to the second lens of the linearly magnifying optical means, so that the linear magnification of the image of the laser beam is optimum.

In other words, this makes it necessary to make the deflected beam snake to limit the footprint of the capturing device on the one hand, and to increase the linear magnification of the image of the laser beam on the other hand, to the benefit of the exploitation of the image acquired by the photosensitive cell.

According to another advantageous aspect, the capturing device also integrates an optical filter interposed between the photosensitive cell and the deflection mirror, to filter waves of the deflected laser beam according to a range of waves acceptable by the photosensitive cell.

Thus, only a useful portion of the waves of the laser beam can be captured by the photosensitive cell, which directly benefits to the ease of exploitation of the captured image since the noise due to the unexploited waves is suppressed, or at least limited, by the presence of the optical filter.

According to another advantageous aspect, the device for displaying the image acquired by the photosensitive cell, connected to the transmission means, is integrated into the system.

The display device enables an operator to obtain a two-dimensional or three-dimensional image of the laser beam, which enables him/her to proceed with the adjustment simply and quickly.

According to another advantageous aspect:
the selection diaphragm is configured to select a portion of the laser beam emitted by the generation module, and to delimit the shape of the impact of the laser beam on a sample to be analyzed,
the lens(es) is/are configured to infinitely project the image of the laser beam coming out of the selection diaphragm,
the focusing optical means are configured to receive the image of the selection diaphragm infinitely projected by the lens(es) and focus it on a sample to be studied so as to produce a plasma on a surface of this sample,
   and the system also comprises means for collecting an optical emission of the plasma and determination means configured to analyze a spectrum of the optical emission and to define an elemental composition of the sample to be studied onto which the laser beam is projected.

According to another advantageous aspect, the system also comprises a computer unit coupled to the photosensitive cell, the computer unit being configured to control actuators dedicated to the adjustment of the laser beam.

The servo-control allows automatically adjusting the laser beam according to the image of the laser beam captured by the photosensitive cell.

This makes the adjustment of the laser beam simpler and more reliable.

The invention also relates to a device for capturing a profile of the laser beam for an analysis system as described before, characterized in that it comprises:
a mirror for deflecting a laser beam, generating a deflected laser beam;
a photosensitive cell intended to acquire an image of the deflected laser beam;
optical means for linearly magnifying the deflected laser beam, interposed between the deflection mirror and the photosensitive cell, and
means for transmitting the image acquired by the photosensitive cell to a display device.

Such a device may be coupled to an analysis device simply and quickly to determine the proper adjustment thereof, and that being so in a non-destructive manner.

This then results in a saving in the operation of an analysis system since the adjustment of the analysis device is simplified and accelerated compared with the prior art, and because it is not necessary to use a test part for the adjustment of the analysis device.

The invention further relates to a method for adjusting an analysis device of an analysis system as described before, characterized in that it comprises the steps of:
positioning the deflection mirror in its deflection position;
generating a laser beam by the generation module;
capturing an image of the deflected beam by the photo-sensitive cell;
analyzing the image captured by the photosensitive cell to detect a profile defect of the laser beam in relation to a theoretical profile;
if a profile defect is detected, correcting an orientation of the generation module and/or of the shaping lens or of the selection diaphragm, and
repeating the steps of capturing, analyzing and correcting until no profile defect is detected in relation to the theoretical profile.

Such a method is quicker and simpler than adjusting the analysis device according to the prior art. While the adjustment is still carried out iteratively, it is nevertheless not subject to ablation of a test part, i.e. to destruction of at least one portion of a test part, said ablation being analyzed to determine a defect in the adjustment of the analysis device.

According to an advantageous aspect, the step of analyzing the image also comprises a sub-step of checking the homogeneity of the intensity of the laser beam, and the correction step is carried out when an inhomogeneity of the intensity of the laser beam is noticed.

This checking sub-step allows further increasing the quality of the adjustment of the analysis device. Indeed, if the profile of the laser beam is good, it is still possible that the intensity of the laser beam is inhomogeneous, which then impairs the operation of the analysis system and therefore the quality of the elemental analysis of a sample to be studied.

According to another advantageous aspect, the method also comprises a step of servo-controlling actuators dedicated to the adjustment of the laser beam.

This servo-control step allows automatically adjusting the laser beam according to the image of the laser beam captured by the photosensitive cell.

This makes the adjustment of the laser beam simpler and more reliable.

### BRIEF DESCRIPTION OF THE DRAWINGS

Other features and advantages of the invention will appear more clearly upon reading the following description of a preferred embodiment of the invention, given as an illustrative and non-limiting example, and from the appended drawings described hereinafter.

FIG. 1 is a schematic representation of a system for elemental analysis by laser beam, according to the invention.

FIG. 2 is a schematic representation of the device for capturing characteristics of the laser beam.

FIG. 3 is a schematic representation of a first type of image obtained using the characteristic capturing device.

FIG. 4 is a schematic representation of a second type of image obtained using the characteristic capturing device.

### DETAILED DESCRIPTION

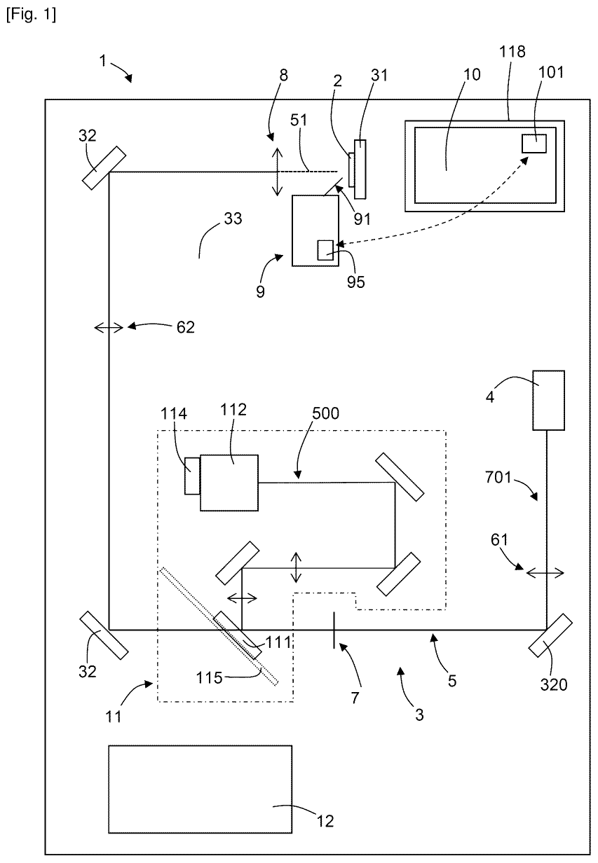

FIG. 1 illustrates a system 1 for elemental analysis of a sample 2 to be studied.

The system 1 includes an analysis device 3 as described hereinafter, this analysis device 3 comprising a stand 31 for receiving the sample 2.

The analysis device 3 also comprises a frame on which are mounted:
a module 4 for generating a laser beam 5,
a module for shaping the laser beam 5 integrating at least one shaping lens 61 and a diaphragm 7 for selecting a portion of the laser beam 5 emitted by the generation module 4,
optical means 8 for focusing the laser beam 5 on the sample 2 to be studied.

As illustrated by FIG. 1, the analysis device 3 comprises, according to the direction of emission of the laser beam 5 from the generation module 4 towards the sample 4, a plurality of lenses including the shaping lens 61 and an auxiliary lens 62 and one single selection diaphragm 7.

The analysis device 3 also comprises a plurality of mirrors 32 allowing deflecting the laser beam 5 from the generation module 4 up to the focusing means 8, in order to limit the footprint of the analysis device 3. At least one of the mirrors 32 is an adjustment mirror 320 positioned between the positioning lens 61 and the selection diaphragm 7.

At the output of the focusing optical means 8, the laser beam 5 becomes a focusing beam 51. In this case, the focusing beam 51 has a conical shape which become progressively thinner in the direction of the sample 2.

Furthermore, the system 1 comprises collection means 9 and determination means 10 the roles of which will be described hereinafter.

The diaphragm 7 is configured to select a portion of the laser beam 5 emitted by the generation module 4, and to delimit the shape of the impact of the laser beam 5 on a sample 2 to be analyzed.

The focusing optical means 8 are configured to receive the image of the selection diaphragm 7 infinitely projected by the lens 6 directly upstream and to focus it on a sample 2 to be studied so as to produce a plasma on a surface of this sample 2.

The collection means 9 are configured to acquire an optical emission of the plasma generated by the impact of the laser beam 5 on the surface of the sample 2 to be analyzed.

Finally, the determination means 10 are configured to analyze a spectrum of the optical emission collected by the collection means 9, and to define an elemental composition of the sample 2 to be studied onto which the laser beam 5 is projected.

As described before, the system 1 allows analyzing a sample 2 to map its elemental composition.

To this end, the laser beam 5 is emitted by the generation module 4 to be directed towards the sample 2 to impact its surface.

When the laser beam 5 impacts the sample 2 to be studied, a plasma P is created, generating an optical emission to be analyzed to map the elements composing the sample 2.

The collection of the optical emission of the plasma is carried out by the collection means 9.

The collection means 9 comprise first communication means 95 intended to establish, with second communication means 101 of the determination means 10, a communication path.

The first communication means 95 and the second communication means 101 may be of the wireless type.

Alternatively, the first communication means 95 and the second communication means 101 may be in the form of connectors intended to receive the plug of a wired connection cable.

To enable the adjustment of the emission of the laser beam 5, the system 1 also includes a device 11 for capturing characteristics of the laser beam 5.

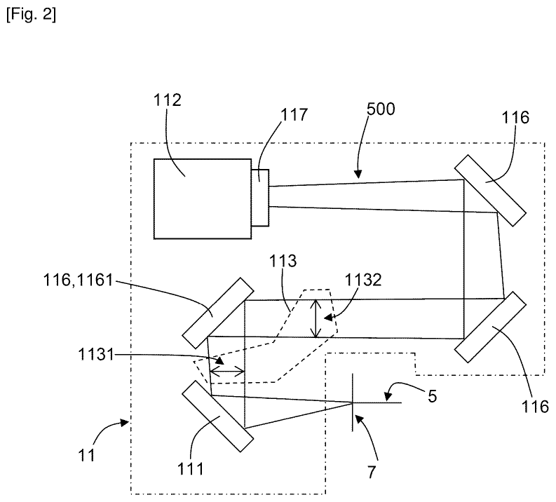

Referring to FIGS. 1 and 2, the capturing device 11 is now described.

Advantageously, the capturing device 11 is removably mounted on the frame of the analysis device 3.

As illustrated by FIGS. 1 and 2, the capturing device 11 comprises:
a mirror 111 for deflecting the laser beam 5;
a photosensitive cell 112 intended to acquire an image of the deflected laser beam 500;
optical means 113 for linearly magnifying the deflected laser beam 500, interposed between the deflection mirror 111 and the photosensitive cell 112, and
means 114 for transmitting the image acquired by the photosensitive cell 112 to a display device 12.

The device 12 for displaying the image acquired by the photosensitive cell 112, connected to the transmission means 114, is integrated into the system 1.

For example, the display device 12 may be in the form of a screen allowing viewing data originating from the determination means 10, be a dedicated mobile screen such as a digital tablet for example, or be in the form of a monitor integrated into the capturing device 11.

The deflection mirror 111, which is in this case a sampling blade, is capable of adopting a deflection position in which it generates a deflected laser beam 500.

For this purpose, the deflection mirror 111 is mounted movable on a member 115 for moving between said deflection position in which it generates the deflected laser beam 500, and a clearance position in which the deflection mirror 111 is brought away from the laser beam 5.

For example, the movement member 115 may be in the form of a support sliding on a rail. In particular, other movement members may be considered such as, for example, members enabling the rotation of the deflection mirror 111 between its deflection position and its clearance position.

As shown in FIG. 2, the optical means 113 for linearly magnifying the deflected laser beam 500 comprise:
a first magnifying lens 1131 having a first focal length f1, and
a second magnifying lens 1132 having a second focal length f2.

The first focal length f1 and the second focal length f2 are different from each other.

More particularly, the first focal length f1 and the second focal length f2 are selected so that the ratio f2/f1 is greater than or equal to 2.

Such a focal ratio allows facilitating the acquisition of an image of the deflected laser beam 500 by the photosensitive cell 112.

Still with reference to FIG. 2, the capturing device 11 comprises a plurality of reflecting mirrors 116 interposed between the deflection mirror 111 and the photosensitive cell 112.

The plurality of reflecting mirrors 116 allows enlarging the deflected beam 500 by redirecting it according to several directions up to the photosensitive cell 112.

This could then allow making the capturing device 11 compact while ensuring the linear magnification of the deflected laser beam to promote image acquisition by the photosensitive cell 112.

Preferably, at least one of the reflecting mirrors 116, so-called the primary reflecting mirror 1161, is positioned between the first magnifying lens 1131 and the second magnifying lens 1132.

Moreover, the capturing device 11 also integrates an optical filter 117 interposed between the photosensitive cell 112 and the deflection mirror 111. This optical filter 117 allows filtering waves of the deflected laser beam 500 according to a wave range acceptable by the photosensitive cell 112.

Thanks to the capturing device 11, the adjustment of the laser beam 5, and therefore of the analysis device 3, is simple and quick in comparison with the methods of the prior art.

Indeed, a technician positions the deflection mirror 111 in its deflection position, i.e. across the laser beam 5, so as to generate the deflected laser beam 5 which is directed towards the photosensitive cell 112.

From the deflection mirror 111 up to the photosensitive cell 112, the deflected laser beam is enlarged by the presence of the first magnifying lens 1131 and the second magnifying lens 1132.

Once the deflected laser beam 500 has reached the photosensitive cell 112, an image of said deflected beam can then be analyzed by the technician, this image being displayed on the display device thanks to the transmission means 114.

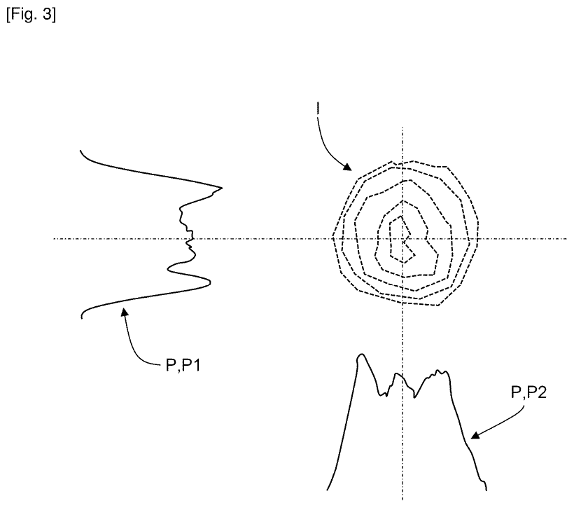

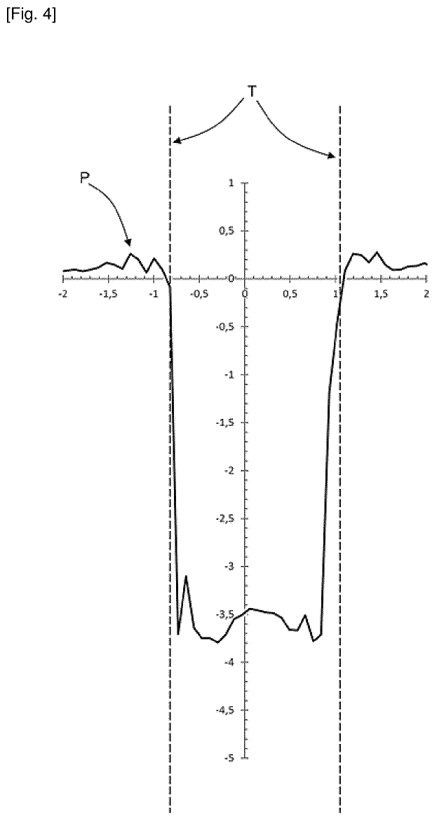

FIGS. 3 and 4 respectively illustrate a first type and a second type of images obtained thanks to the photosensitive cell 112.

Starting from an image I of the laser beam 5, it is possible to obtain different profiles P of the laser beam 5.

Referring to FIG. 3, a first profile P1 may be defined in a first plane, and a second profile P2 may be defined in a second plane.

As illustrated by FIG. 3, the image I shows that the laser beam 5 has a plurality of substantially concentric intensity areas which define the profile of the laser beam 5.

Referring to FIG. 4, the position adjustment of the generation module 4, of the shaping lens 61, of the selection diaphragm 7, or of the adjustment mirror 320 aims to bring the profile P of the laser beam 5 closer to a theoretical profile T which takes on a substantially cylinder shape.

By having a profile P close to the theoretical profile T, the laser beam 5 enables a controlled impact on the sample, favoring a noise-free plasma, and therefore an improved analysis.

Based on the obtained images, the technician can modify the positioning of the generation module 4, of the positioning lens 61, of the selection diaphragm 7, or of the adjustment mirror 320 so that the laser beam 5 has the desired characteristics, i.e. characteristics identical to, or at least as close as possible to, those of a theoretical laser beam. For example, this modification may be made manually.

Moreover, the photosensitive cell 112 may be coupled to a computer unit 118 allowing servo-controlling the positioning of the generation module 4, of the positioning lens 61, of the selection diaphragm 7, or of the adjustment mirror 320 so that the laser beam 5 has the desired characteristics. Actuators may then be provided to enable the position adjustment of the generation module 4, of the positioning lens 61, of the selection diaphragm 7, or of the adjustment mirror 320.

In other words, the computer unit is configured to control actuators dedicated to the adjustment of the laser beam 5.

For indication, the theoretical laser beam has a substantially cylindrical shape and a homogeneity of intensity in section.

When the laser beam 5 is poorly centered, it has neither an intensity homogeneity nor a desired profile, which causes a partial ablation of the sample 2 and, as a consequence, a poor plasma quality and therefore a difficulty and even the impossibility of properly mapping the sample 2. In other words, a non-circular crater geometry with a size larger than desired and having an extended HAZ (Heat-Affected Zone) disturbing the measurements.

Thanks to the capturing device 11, the time of adjusting the system 1 is considerably reduced and can be performed visually, to the benefit and speed of adjustment of the analysis device 3, and therefore of the analysis quality.

Although the present disclosure has been described with reference to one or more examples, workers skilled in the art will recognize that changes may be made in form and detail without departing from the scope of the disclosure and/or the appended claims.

1. A system for elemental analysis of a sample to be studied, the system comprising:
an analysis device comprising a frame on which are mounted:
a laser source for generating a laser beam,
laser shaping element to shape the laser beam, which comprises at least one shaping lens and a diaphragm which selects a portion of the laser beam emitted by the laser source,
a focusing optical element, which focusses the laser beam on the sample to be studied;
a capturing device configured to capture characteristics of the laser beam emitted by the laser source, interposed between the laser shaping element and the focusing optical element, the capturing device comprising:
a mirror which deflects the laser beam and is capable of adopting a deflection position in which the mirror generates a deflected laser beam;
a photosensitive cell to acquire an image of the deflected laser beam;
optics, which linearly magnify the deflected laser beam, and are interposed between the deflection mirror and the photosensitive cell, and
a transmitter for transmitting the image acquired by the photosensitive cell to a display device.

2. The system according to claim 1, wherein the optics for linearly magnifying the deflected laser beam comprise:
a first magnifying lens having a first focal length f1, and
a second magnifying lens having a second focal length f2,
the first focal length f1 and the second focal length f2 being selected so that the ratio f2/f1 is greater than or equal to 2.

3. The system according to claim 1, wherein the capturing device is removably mounted on the frame.

4. The system according to claim 1, wherein the capturing device comprises a plurality of reflecting mirrors interposed between the deflection mirror and the photosensitive cell, to enlarge the deflected beam by redirecting the deflected beam according to several directions up to the photosensitive cell.

5. The system according to claim 1, wherein the capturing device also comprises an optical filter interposed between the photosensitive cell and the deflection mirror, to filter waves of the deflected laser beam according to a wave range acceptable by the photosensitive cell.

6. The system according to claim 1, wherein the device for displaying the image acquired by the photosensitive cell, connected to the transmitter is integrated into the system.

7. The system according to claim 1, wherein:
the diaphragm is configured to select a portion of the laser beam emitted by the laser source, and to delimit a shape of an impact of the laser beam on a sample to be analyzed,
the at least one lens is configured to infinitely project the image of the laser beam at an output of the diaphragm,
the focusing optical element is configured to receive the image of the diaphragm infinitely projected by the at least one lens and focus the image on the sample to be studied so as to produce a plasma on a surface of the sample, and
the system also comprises an optical collector configured to collect an optical emission of the plasma and a computer unit_configured to analyze a spectrum of the optical emission and to define an elemental composition of the sample to be studied onto which the laser beam is projected.

8. The system according to claim 1, wherein the system further comprises a computer unit coupled to the photosensitive cell, the computer unit being configured to control actuators dedicated to the adjustment of the laser beam.

9. (canceled)

10. An adjustment method for adjusting an analysis device of an analysis system according to claim 1, wherein the method comprises:
positioning the deflection mirror in the deflection position;
generating the laser beam by the laser source;
capturing the image of the deflected beam by the photosensitive cell;
analyzing the image captured by the photosensitive cell to detect a profile defect of the laser beam in relation to a theoretical profile;
in response to the profile defect being detected, correcting an orientation of the laser source and/or of the at least one shaping lens or of the diaphragm, and
repeating the capturing, analyzing and correcting until no profile defect is detected in relation to the theoretical profile.

11. The adjustment method according to claim 10, wherein analyzing the image also comprises checking homogeneity of an intensity of the laser beam, and wherein the correcting is carried out when an inhomogeneity of the intensity of the laser beam is noticed.

12. The method according to claim 10, claim 1, wherein the method further comprises servo-controlling actuators dedicated to the adjustment of the laser beam.
